(19) United States
(12) Patent Application Publication
(10) Pub. No.: US 2020/0306912 A1
(43) Pub. Date: Oct. 1, 2020

(54) MONITORING DEVICE, MONITORING SYSTEM AND MONITORING METHOD

(71) Applicant: FANUC CORPORATION, Minamitsuru-gun (JP)

(72) Inventor: Tohru NISHI, Minamitsuru-gun (JP)

(21) Appl. No.: 16/835,680

(22) Filed: Mar. 31, 2020

(30) Foreign Application Priority Data
Apr. 1, 2019 (JP) 2019-069963

(51) Int. Cl. B23Q 17/09; G01M 13/00; B23Q 1/70

(52) U.S. Cl. CPC B23Q 17/0957; B23Q 1/70; G01M 13/00

(57) ABSTRACT

A monitoring device includes: a distribution generating unit configured to generate an execution time distribution that is a frequency distribution of an execution time of the program; a storage unit configured to store at least one kind of abnormality information indicative of an execution time distribution as to an abnormality; a calculation unit configured to calculate an occurrence probability of abnormality, based on information indicating the execution time distribution generated by the distribution generating unit and the abnormality information stored in the storage unit; a threshold setting unit configured to set a probability threshold for the abnormality information; and a determination unit configured to determine that there is a sign of an abnormality when the occurrence probability is equal to or higher than the probability threshold.

### CROSS-REFERENCE TO RELATED APPLICATION

This application is based upon and claims the benefit of priority from Japanese Patent Application No. 2019-069963 filed on Apr. 1, 2019, the contents of which are incorporated herein by reference.

### BACKGROUND OF THE INVENTION

### Field of the Invention

The present invention relates to a monitoring device, a monitoring system, and a monitoring method for monitoring the processing time of at least one program that is repeatedly executed in a machining cycle of a processing machine.

### Description of the Related Art

There are some cases in which a processing machine monitors information obtained from the processing machine in order to find a sign of an abnormality. Japanese Laid-Open Patent Publication No. 2016-215311 discloses a technique in which the spindle stop time from start of a spindle motor coasting to the stoppage is measured and stored in a storage unit, and multiple pieces of spindle stop time data stored in the storage unit are compared to judge whether or not the spindle or the spindle motor has an abnormality based on the result of the comparison.

### SUMMARY OF THE INVENTION

However, according to the technology disclosed in Japanese Laid-Open Patent Publication No. 2016-215311, since the presence or absence of an abnormality is predicted based on the spindle stop time from start of the spindle motor coasting to the stoppage, it is impossible to find abnormalities of components other than the spindle and the spindle motor.

It is therefore an object of the present invention to provide a monitoring device, a monitoring system, and a monitoring method capable of comprehensively finding abnormalities of a processing machine.

A first aspect of the present invention is a monitoring device for monitoring a processing time of at least one type of program repeatedly executed in a machining cycle of a control device for controlling a processing machine, the monitoring device including: a distribution generating unit configured to generate an execution time distribution that is a frequency distribution of an execution time of the program; a storage unit configured to store at least one kind of abnormality information indicative of an execution time distribution as to an abnormality; a calculation unit configured to calculate an occurrence probability of abnormality, based on information indicating the execution time distribution generated by the distribution generating unit and the abnormality information stored in the storage unit; a threshold setting unit configured to set a probability threshold for the abnormality information; and a determination unit configured to determine that there is a sign of an abnormality when the occurrence probability is equal to or higher than the probability threshold.

A second aspect of the present invention is a monitoring system, which includes: the above monitoring device; a plurality of processing machines; a plurality of control devices configured to control the respective processing machines; and a management server configured to manage the plurality of control devices.

A third aspect of the present invention is a monitoring method for monitoring a processing time of at least one type of program repeatedly executed in a machining cycle of a control device for controlling a processing machine, the method including: a distribution generating step of generating an execution time distribution that is a frequency distribution of an execution time of the program; a calculating step of calculating an occurrence probability of abnormality, based on the information indicating the execution time distribution generated at the distribution generating step and at least one kind of abnormality information indicative of an execution time distribution as to an abnormality, stored in a storage unit; a threshold setting step of setting a probability threshold for the abnormality information; and a determining step of determining that there is a sign of an abnormality when the occurrence probability is equal to or higher than the predetermined probability threshold.

According to the present invention, no matter what abnormality is, a sign of an abnormality can be determined based on the tendency of the frequency concerning execution time of a program repeatedly executed in a machining cycle. As a result, it is possible to comprehensively detect abnormalities of a processing machine.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic diagram illustrating a monitoring system configuration;

FIG. 2 is a schematic diagram illustrating a monitoring device configuration;

FIG. 3 is a conceptual diagram showing how an execution time distribution is generated;

FIG. 4 is a diagram showing an example of an execution time distribution;

FIG. 5 is a diagram illustrating a normal execution time distribution and an execution time distribution right before occurrence of an abnormality;

FIG. 6 is a diagram showing a configuration example of a distribution generating unit;

FIG. 7 is a flowchart illustrating a flow of a distribution generating process;

FIG. 8 is a flowchart illustrating a flow of an abnormality information generating process; and

FIG. 9 is a flowchart illustrating a flow of an abnormality sign determining process.

### DESCRIPTION OF THE PREFERRED EMBODIMENTS

The present invention will be detailed below by describing a preferred embodiment with reference to the accompanying drawings.

### EMBODIMENT

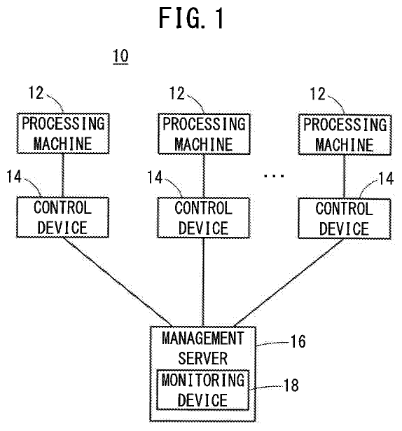

FIG. 1 is a schematic diagram showing a configuration of a monitoring system 10. The monitoring system 10 includes a plurality of processing machines 12, a plurality of control devices 14 each controlling the associated processing machine 12, a management server 16 managing the multiple control devices 14, and a monitoring device 18 built in the management server 16. The multiple control devices 14 and the management server 16 are connected via networks.

The multiple processing machines 12 each machine a workpiece. At least one of the multiple processing machines 12 may be different in type from the other processing machines 12. Examples of the types of the processing machines 12 include machine tools and electrical discharge machines.

The multiple control devices 14 each control the associated processing machine 12 every machining cycle so as to machine the workpiece. When an abnormality occurs in one of the processing machines 12, the associated control device 14 stops operation of the processing machine 12, i.e., the device 14 implements an abnormality stop on the processing machine 12, and outputs an abnormality warning signal containing a unique identifier (hereinafter, referred to as an alarm number) corresponding to the type of the occurring abnormality, to the management server 16.

The management server 16 exchanges various signals with each of the multiple control devices 14 to manage the multiple control devices 14. For example, the management server 16, based on a signal from one of the control devices 14, recognizes the state of the processing machine 12 controlled by the one control device 14, and compensates the command values to be output from the control device 14 to the processing machine 12, in accordance with the recognition result.

The monitoring device 18 monitors the processing time of the program executed in the machining cycle. In the machining cycle, the control device 14 repeatedly runs programs continuously or intermittently. Generally, the control device 14 repeatedly executes multiple kinds of programs in one machining cycle, but may run only one kind of program. Examples of the programs include control programs for axial feed motors, control programs for rotary shaft motors, movement control programs for additional axes, programs for writing to storage, flow rate control programs for cutting fluid, etc., a temperature control program of a work-pan, an image recognition program for process check, and communication programs with external devices. That is, in a machining cycle, at least one kind of program is repeatedly executed.

The monitoring device 18 monitors, for each type of program, the processing time of the program executed in each machining cycle of the control device 14, based on the signal acquired from each of the multiple control devices 14.

Since the monitoring device 18 monitors the same contents for each of the multiple control devices 14, the way that the monitoring device 18 monitors one of the control devices 14 will be described hereinbelow. Also, since the monitoring device 18 monitors the same contents for each of the various programs, the way of the monitoring device 18 monitoring one of the programs will be described hereinbelow.

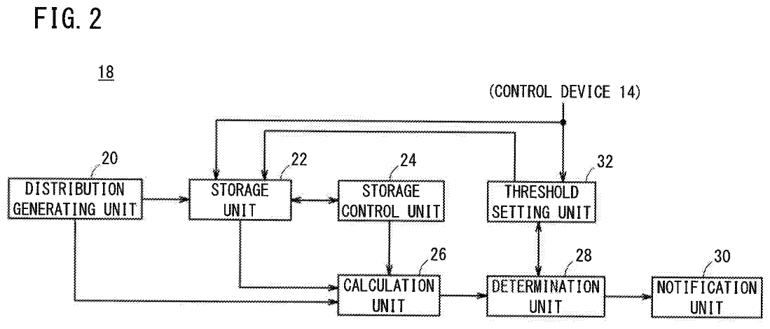

FIG. 2 is a schematic diagram showing a configuration of the monitoring device 18. The monitoring device 18 includes a distribution generating unit 20, a storage unit 22, a storage control unit 24, a calculation unit 26, a determination unit 28, a notification unit 30 and a threshold setting unit 32.

The storage unit 22 is hardware, whereas the distribution generating unit 20, the storage control unit 24, the calculation unit 26, the determination unit 28, the notification unit 30 and the threshold setting unit 32 may be either hardware or software. When the distribution generating unit 20, the storage control unit 24, the calculation unit 26, the determination unit 28, the notification unit 30 and the threshold setting unit 32 are software, the monitoring device 18 includes a processor, and the storage unit 22 is stored with a monitoring program. The processor runs the monitoring program so that the monitoring device 18 functions as the distribution generating unit 20, the storage control unit 24, the calculation unit 26, the determination unit 28, the notification unit 30 and the threshold setting unit 32.

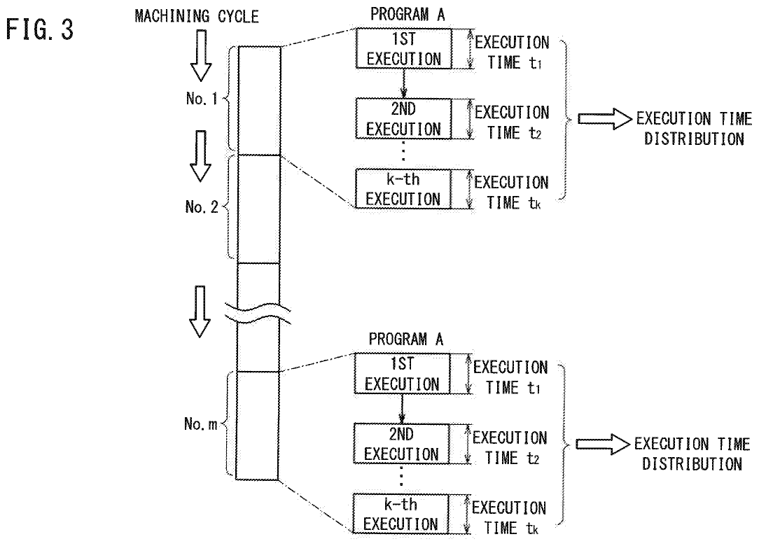

The distribution generating unit 20 generates a frequency distribution of program execution time (hereinafter, referred to as an execution time distribution). As shown in FIG. 3, for each machining cycle the distribution generating unit 20 measures the execution time and the number of times the program is continuously or intermittently repeated by the control device 14 during the machining cycle, and generates an execution time distribution based on the measurement result.

Each program has, assigned thereto, a unique identifier (program number) corresponding to the program type. Therefore, the distribution generating unit 20 measures the execution time and the number of times of executions concerning the program having the same identifier (program number), to thereby generate an execution time distribution of the program corresponding to the identifier.

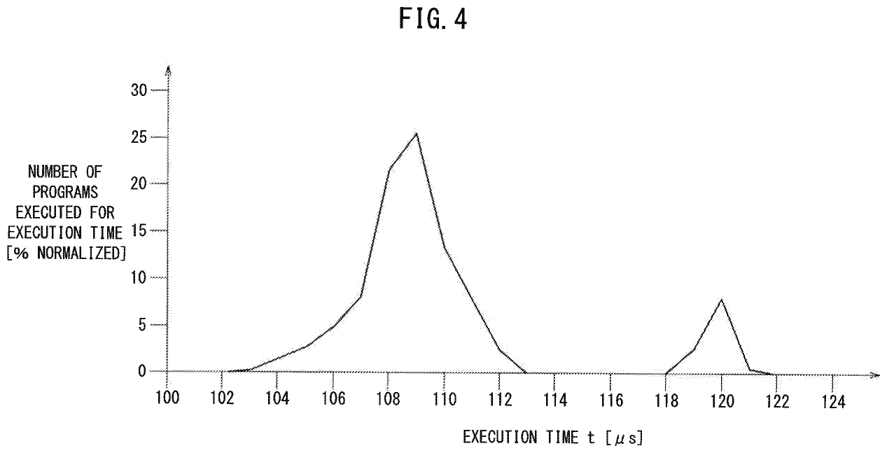

FIG. 4 is a diagram showing an execution time distribution example, and more specifically shows an execution time distribution concerning a program having the same identifier (program number). In FIG. 4, the number of programs executed for execution time on the vertical axis is normalized as a ratio of the number of times the program was executed for each execution time to the total number of times the program was executed in one machining cycle, but may not be necessarily normalized. The distribution generating unit 20, by generating the execution time distribution, can grasp the tendency of the frequency of the program being executed for the respective execution times in the machining cycle, as exemplified in FIG. 4.

When an execution time distribution is generated, the distribution generating unit 20 stores the generated execution time distribution in the storage unit 22 and outputs the generated execution time distribution to the calculation unit 26.

The storage unit 22 stores various types of information. Examples of the storage unit 22 include storage media such as hard disk and portable memory. The storage unit 22 stores in advance normal execution time distributions. The normal execution time distribution is a frequency distribution of the execution time of a program executed during a machining cycle when the machine operates normally. A normal execution time distribution is stored in advance in the storage unit 22 for each type of program.

The storage control unit 24 causes the storage unit 22 to store abnormality information indicating an execution time distribution occurring in a case of abnormality (which will be hereinafter referred to as an abnormal execution time distribution). In this embodiment, the abnormal execution time distribution corresponds to an execution time distribution generated by the distribution generating unit 20 in the machining cycle immediately before stoppage due to abnormality (which also will be hereinafter referred to as abnormality stop), and the information on the abnormal execution time distribution is given as a distribution difference between the execution time distribution generated by the distribution generating unit 20 and the normal execution time distribution.

When the storage control unit 24 receives an abnormality warning signal from the control device 14, the storage control unit 24 reads out the normal execution time distribution and the execution time distribution generated by the distribution generating unit 20 during the previous machining cycle, i.e., during the machining cycle right before the current machining cycle in which the abnormality warning signal has been received, from the storage unit 22. The storage control unit 24 calculates the distribution difference between the read execution time distribution and the normal execution time distribution. In this embodiment, the storage control unit 24 calculates, as the distribution difference, a difference (average value difference) between the average of the execution time distribution read from the storage unit 22 and the average of the normal execution time distribution.

Specifically, the storage control unit 24 can calculate the average value difference using the following equation:

ΔAverage(P_{N},P_{A})=Eₜ₌₀^{∞}t{P_{A}(t)−P_{N}(t)} (1)

where the execution time of the program is t, the ratio of the number of program executions for the execution time in the normal state is P_{N}(t), the ratio of the number of program executions for the execution time in the abnormal state is P_{A}(t), and the average value difference is ΔAverage (P_{N}, P_{A}).

After calculating the distribution difference (average value difference), the storage control unit 24 stores in the storage unit 22 the calculated distribution difference as abnormality information in association with an alarm number included in the abnormality warning signal received from the control device 14.

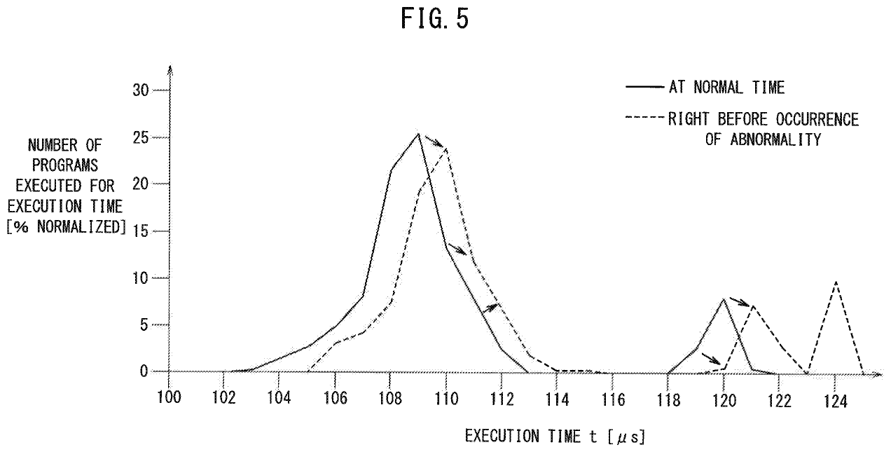

FIG. 5 is a diagram exemplifying a normal execution time distribution and an execution time distribution immediately before the occurrence of abnormality. The execution time distribution immediately before the occurrence of abnormality is different from the normal execution time distribution. Specifically, in the example of FIG. 5, the execution time distribution immediately before the occurrence of abnormality is shifted to the right side in the drawing from the normal execution time distribution. A cause of this is considered to be that, for example, the execution time of the program is varied due to wear of the tool of the processing machine 12. Further, in the example of FIG. 5, a local peak that was not in the normal execution time distribution appears in the execution time distribution immediately before the occurrence of abnormality. A cause of this may be considered as, for example, occurrence of a new process in response to conditional branching of the program.

That is, the distribution difference is an amount of change of the execution time distribution generated by the distribution generating unit 20 immediately before operation of the processing machine 12 is actually stopped due to abnormality, from the normal execution time distribution, and indicates a characteristic sign of abnormality. The storage control unit 24 stores, as abnormality information, the above-described distribution difference in the storage unit 22, so that it is possible to grasp a characteristic sign occurring at a time when an abnormality occurs every time the processing machine 12 actually undergoes abnormality stop.

The calculation unit 26 calculates the probability of occurrence of abnormality based on the information indicating the execution time distribution generated by the distribution generating unit 20 and the abnormality information stored in the storage unit 22. The calculation unit 26 calculates the probability of occurrence of abnormality each time the execution time distribution output from the distribution generating unit 20 is obtained.

That is, upon acquiring the execution time distribution output from the distribution generating unit 20, the calculation unit 26 reads out the normal execution time distribution from the storage unit 22, and calculates the distribution difference between the read normal execution time distribution and the execution time distribution obtained from the distribution generating unit 20.

The calculation unit 26 reads out all pieces of abnormality information (distribution differences) stored in the storage unit 22 when the execution time distributions have been acquired from the distribution generating unit 20. Here, when there is only a single piece of abnormality information read from the storage unit 22, the calculation unit 26 calculates a difference between the single piece of abnormality information (distribution difference), and the distribution difference between the execution time distribution acquired from the distribution generating unit 20 and the normal execution time distribution. After calculation of the difference, the calculation unit 26 multiplies the calculated difference by a predetermined coefficient (degree of influence) and puts the multiplication result into a ramp function to calculate a value, which is determined to be the probability of occurrence of the abnormality as to the single piece of abnormality information.

In contrast, when there are multiple pieces of abnormality information read from the storage unit 22, the calculation unit 26 calculates the differences for the respective pieces of abnormality information. After calculation of all the differences, the calculation unit 26 multiplies each of the calculated differences by a predetermined coefficient (degree of influence), adds them, and then puts the result of addition into a ramp function to calculate a value, which is determined to be the probability of occurrence of the abnormality as to each of the multiple kinds of abnormality information.

Specifically, the calculation unit 26 can calculate the occurrence probability of abnormality as to at least one kind of abnormality information using the following equation:

ALARMⱼ=Ramp(1−Σₙ₋₁^{N}A_{(j,n)}·|ΔDistance_{(j,n)}|), (2)

where j is the alarm number, N is the number of pieces of abnormality information (distribution differences) stored in the storage unit 22 in association with the alarm number, n indicates each abnormality information (distribution difference), A (j, n) is the aforementioned degree of influence, ΔDistance (j, n) is the aforementioned difference, and ALARMj is the probability of occurrence of the abnormality.

Upon calculating the probability of occurrence of abnormality as to at least one kind of abnormality information, the calculation unit 26 outputs the calculated probability of occurrence to the determination unit 28.

The determination unit 28 determines whether or not there is a sign of an abnormality based on the occurrence probability calculated by the calculation unit 26. Upon acquiring the occurrence probability for the abnormality information output from the calculation unit 26, the determination unit 28 compares the occurrence probability with a probability threshold set by the threshold setting unit 32 for the abnormality information.

When the comparison result shows that the obtained occurrence probability is less than the probability threshold, the determination unit 28 determines that there is no sign of abnormality. On the other hand, when the comparison result shows that the obtained occurrence probability is equal to or higher than the probability threshold, the determination unit 28 determines that there is a sign of an abnormality. Specifically, the determination unit 28 determines that there is a sign of an abnormality of the alarm number associated with the abnormality information corresponding to the occurrence probability that is equal to or higher than the probability threshold.

When the calculation unit 26 calculates multiple occurrence probabilities for multiple kinds of abnormality information, the determination unit 28 compares the occurrence probability for each of the multiple kinds of abnormality information with the probability threshold set for the corresponding kind of abnormality information.

The determination unit 28 determines that there is no sign of abnormality when the comparison result shows that all the occurrence probabilities are less than the associated probability threshold. On the other hand, if there is any one of the occurrence probabilities that is equal to or greater than the probability threshold, the determination unit 28 determines that there is a sign of an abnormality of the alarm number associated with the abnormality information corresponding to the occurrence probability that is equal to or greater than the probability threshold.

When the determination unit 28 determines that there is a sign of an abnormality, the determination unit 28 outputs the determination result to the notification unit 30 and the threshold setting unit 32. Specifically, the determination unit 28 generates a determination result signal indicating that there is a sign of an abnormality of the determined alarm number, and outputs the generated determination result signal to the notification unit 30 and the threshold setting unit 32.

The notification unit 30 outputs a notification that there is a possibility that the processing machine 12 may be abnormally stopped due to the abnormality determined by the determination unit 28. Upon acquiring the determination result signal output from the determination unit 28, the notification unit 30 notifies a user or an operator of, for example, the alarm number together with a warning message indicating that there is a possibility of an abnormality stop, on the basis of the determination result signal.

The notification unit 30 can alert the operator to be careful of the abnormality stop of the processing machine 12 by notifying the operator that an abnormality stop may occur. In addition, the notification unit 30 can notify the operator of the alarm number, so as to let the operator to know what kind of abnormality may cause the abnormality stop.

When the monitoring device 18 includes at least one of a display unit, a speaker and a light-emitting unit, the notification unit 30 may notify the operator that there is a possibility of the processing machine 12 being abnormally stopped due to an abnormality identified by the determination unit 28, by using at least one of the display unit, the speaker and the light-emitting unit. When an external device including at least one of a display unit, a speaker and a light emitting unit is connected to the monitoring device 18, the notification unit 30 may notify the operator that there is a possibility of the processing machine 12 being abnormally stopped due to an abnormality identified by the determination unit 28, by transmitting an operation signal to the external device.

The threshold setting unit 32 sets a probability threshold for abnormality information. When acquiring the determination result signal output from the determination unit 28, the threshold setting unit 32 identifies the alarm number for which it has been determined that there is a sign of an abnormality based on the determination result signal, and sets a probability threshold for the abnormality information related to the identified alarm number.

Also, the threshold setting unit 32 determines whether the processing machine 12 has abnormally stopped due to the abnormality expected to occur by the determination unit 28 within a predetermined period of time from when the determination unit 28 has determined that there is a sign of abnormality.

That is, if the threshold setting unit 32 does not receive the abnormality warning signal from the control device 14 within the predetermined time from a time of acquisition of the determination result signal output from the determination unit 28, the threshold setting unit 32 determines that the processing machine 12 has not stopped abnormally due to the abnormality expected to occur by the determination unit 28. In this case, the threshold setting unit 32 increases the probability threshold that has already been set for the abnormality information. This makes it possible to reduce erroneous determination of the determination unit 28.

If the probability threshold is excessively increased, it becomes difficult to determine whether there is a sign of an abnormality for the abnormality information corresponding to the probability threshold, and the reliability of the abnormality information tends to be questionable. Therefore, when the probability threshold becomes equal to or greater than a specified value, the threshold setting unit 32 deletes from the storage unit 22 the abnormality information corresponding to the probability threshold that has become equal to or greater than the specified value. With this configuration, it is possible to suppress erroneous determination of the determination unit 28.

On the other hand, when receiving the abnormality warning signal from the control device 14 within the predetermined time after acquisition of the determination result signal output from the determination unit 28, the threshold setting unit 32 checks whether the processing machine 12 has abnormally stopped due to the abnormality expected to occur by the determination unit 28. Specifically, the threshold setting unit 32 checks whether the alarm number included in the abnormality warning signal coincides with the alarm number for which it has been determined that there is a sign of the abnormality based on the determination result signal output from the determination unit 28. If they coincide with each other, it is regarded that the processing machine 12 has undergone abnormality stop due to the abnormality expected to occur by the determination unit 28. In this case, the threshold setting unit 32 lowers the probability threshold already set for the abnormality information. Accordingly, it is possible to easily grasp the sign of the abnormality that has actually occurred.

In the above case, if the alarm number included in the abnormality warning signal does not coincide with the alarm number for which it has been determined that there is a sign of the abnormality based on the determination result signal output from the determination unit 28, it is understood that the processing machine 12 must have abnormally stopped due to an abnormality other than the abnormality that was expected to occur by the determination unit 28. In this case, the threshold setting unit 32 newly sets another probability threshold without changing the already set probability threshold. That is, as described above, the threshold setting unit 32 recognizes the alarm number based on the determination result signal output from the determination unit 28, and sets the probability threshold for the abnormality information associated with the recognized alarm number.

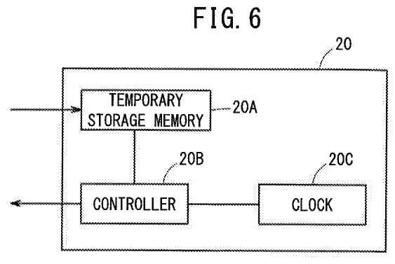

Next, a specific configuration example of the distribution generating unit 20 will be described. FIG. 6 is a diagram illustrating a configuration example of the distribution generating unit 20. The distribution generating unit 20 includes a temporary storage memory 20A, a controller 20B, and a clock 20C.

The temporary storage memory 20A stores cycle numbers and program numbers. A cycle number is generated by the control device 14 in synchronization with a machining cycle in the control device 14 and is output from the control device 14. A program number is generated by the control device 14 in synchronization with a program executed by the control device 14 and is output from the control device 14.

The controller 20B measures the execution time and the number of times a program is repeatedly executed by the control device 14 during the machining cycle for each machining cycle, based on the cycle number and the program number stored in the temporary storage memory 20A and by using the clock 20C. When one machining cycle is completed, the controller 20B generates an execution time distribution based on the execution time and the number of times of program executions, measured during the machining cycle, and stores the generated execution time distribution in the storage unit 22.

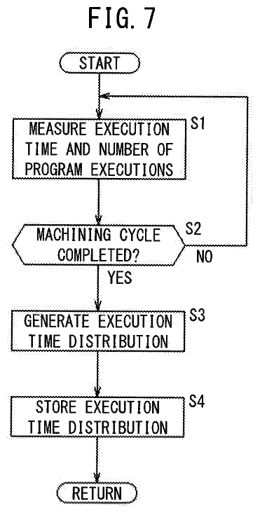

Next, in regard to the monitoring method of the monitoring device 18, a distribution generating process of the monitoring device 18 will be described. This distribution generating process is executed from when the control device 14 starts the control of machining the workpiece into a desired shape to the end of the control. FIG. 7 is a flowchart showing the flow of the distribution generating process.

At step S1, the distribution generating unit 20 measures the execution time and the number of times the program is executed in the control device 14. Then, at step S2, it is determined whether or not one machining cycle has been completed. When the distribution generating unit 20 determines that one machining cycle has not yet been completed, the control returns to step S1. When it is determined that the machining cycle has been completed, the control proceeds to step S3.

At step S3, the distribution generating unit 20 generates an execution time distribution based on the execution time and the number of times of the program executions, measured at step S1. At step S4, the generated execution time distribution is stored into the storage unit 22. Then, the control returns to step S1.

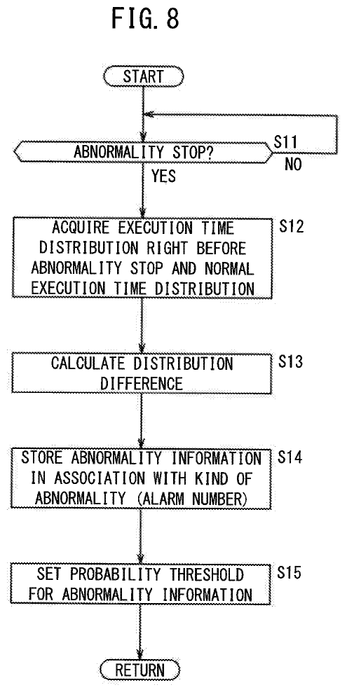

Next, in regard to the monitoring method of the monitoring device 18, an abnormality information generating process of the monitoring device 18 will be described. This abnormality generating process is executed in parallel with the above distribution generating process. FIG. 8 is a flowchart showing the flow of the abnormality information generating process.

At step S11, the storage control unit 24 determines whether or not the processing machine 12 has stopped abnormally. Here, when the storage control unit 24 receives no abnormality warning signal from the control device 14, the storage control unit 24 determines that the processing machine 12 has not been abnormally stopped, and the control repeats step S11. On the other hand, when the storage control unit 24 receives an abnormality warning signal from the control device 14, the storage control unit 24 determines that the processing machine 12 has abnormally stopped, and the control proceeds to step S12.

At step S12, the storage control unit 24 reads out from the storage unit 22 and obtains the normal execution time distribution and the execution time distribution generated in the previous machining cycle, i.e., in the machining cycle immediately before the machining cycle in which the abnormality warning signal was received at step S11, and the control proceeds to step S13. At step S13, the storage control unit 24 calculates the distribution difference (average value difference) between the execution time distribution read at step S12 and the normal execution time distribution, and the control proceeds to step S14.

At step S14, the storage control unit 24 stores, as abnormality information, the distribution difference calculated at step S13 in association with the alarm number, in the storage unit 22, and the control proceeds to step S15. At step S15, the threshold setting unit 32 sets a probability threshold for the abnormality information stored at step S14, and the control returns to step S11.

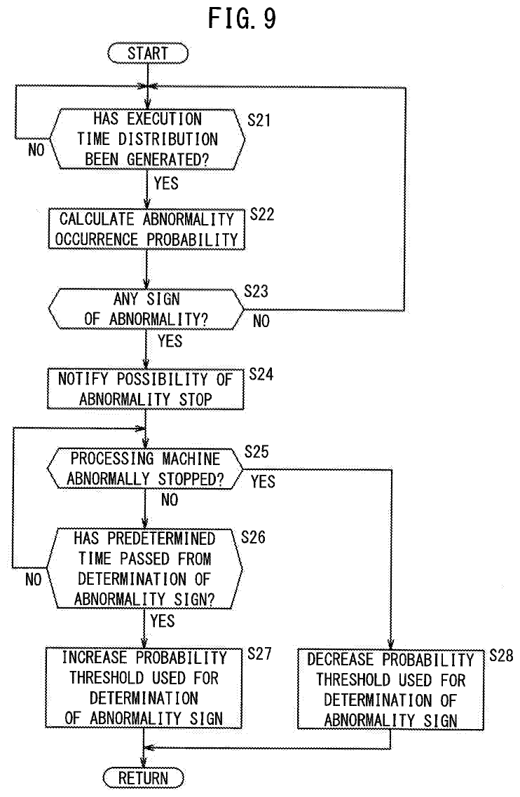

Next, in regard to the monitoring method of the monitoring device 18, an abnormality sign determination process of the monitoring device 18 will be described. The abnormality information sign determination process is executed in parallel with the above distribution generating process and abnormality information generating process after at least one kind of abnormality information is stored in the storage unit 22. FIG. 9 is a flowchart showing the flow of the abnormality sign determination process.

At step S21, the calculation unit 26 determines whether or not the execution time distribution has been generated at step S3 in the distribution generating process. Here, if the execution time distribution has not been generated, the calculation unit 26 repeats step S21, and if the execution time distribution has been generated, the operation proceeds to step S22.

At step S22, the calculation unit 26 reads out all of at least one kind of abnormality information stored in the storage unit 22. In addition, the calculation unit 26 calculates the occurrence probability of abnormality for the abnormality information read from the storage unit 22, based on the abnormality information read from the storage unit 22 and the execution time distribution generated at step S3 of the above distribution generating process, and the control proceeds to step S23.

At step S23, the determination unit 28 compares the occurrence probability of abnormality for at least one kind of abnormality information calculated at step S22 with a probability threshold set for this abnormality information. The probability threshold is a threshold set at step S15 of the above-described abnormality information generating process.

Here, when all the occurrence probabilities of the abnormalities for one or multiple kinds of abnormality information are less than the respective probability thresholds, the determination unit 28 determines that there is no sign of abnormality, and returns to step S21. On the other hand, when at least one of the occurrence probabilities of the abnormalities for one or multiple kinds of abnormality information is equal to or greater than the associated probability threshold, the determination unit 28 determines that there is a sign of the abnormality of the alarm number associated with the abnormality information for which the occurrence probability is equal to or greater than the probability threshold. Then, the control proceeds to step S24.

At step S24, the notification unit 30 notifies a user or an operator that there is a possibility that the processing machine 12 may be abnormally stopped due to the abnormality determined to occur at step S23, and the control proceeds to step S25. At step S25, the threshold setting unit 32 determines whether or not the processing machine 12 has abnormally stopped due to the abnormality expected to occur at step S23.

When the threshold setting unit 32 has not received any abnormality warning signal from the control device 14, the threshold setting unit 32 determines that the processing machine 12 has not undergone an abnormality stop, and the control proceeds to step S26, in which it is determined whether a predetermined time has passed from when the determination at step S23 was made.

Here, when the threshold setting unit 32 does not receive any abnormality warning signal from the control device 14 until the predetermined time elapses after the determination at step S23, the control proceeds to step S27. At step S27, the threshold setting unit 32 increases the probability threshold used when it was determined that there was a sign of an abnormality at step S23, and the control returns to step S21.

On the other hand, when the threshold setting unit 32 receives the abnormality warning signal from the control device 14 before the predetermined time elapses after the determination at step S23, the control proceeds to step S28. At step S28, the threshold setting unit 32 decreases the probability threshold used when it was determined at step S23 that there was a sign of an abnormality, and the control returns to step S21.

### Modified Examples

Though the above embodiment has been described as one example of the present invention, the technical scope of the invention should not be limited to the above embodiment. It goes without saying that various modifications and improvements can be added to the above embodiment. It is also apparent from the scope of claims that the embodiment added with such modifications and improvements should be incorporated in the technical scope of the invention.

### Modified Example 1

In the above embodiment, the storage control unit 24 calculates the average value difference as the distribution difference between the execution time distribution read from the storage unit 22 and the normal execution time distribution. However, the storage control unit 24 may calculate any other value than the average value difference as long as the value indicates a distribution difference between the execution time distribution read from the storage unit 22 and the normal execution time distribution.

Examples of the distribution differences include the median difference, the variance difference, the difference-in-area, and the number of mismatched peaks (i.e., peaks in disagreement). The median difference is a difference between the center on the time axis of the execution time distribution read from the storage unit 22 and the center on the time axis of the normal execution time distribution. The variance difference is a difference between the variance of the execution time distribution read from the storage unit 22 and the variance of the normal execution time distribution. The difference-in-area is obtained by calculating, as an area, the difference between the frequency of the execution time distribution read from the storage unit 22 and the frequency of the normal execution time distribution. The number of mismatched peaks is the number of the peaks wherein a peak in the execution time distribution read from the storage unit 22 and the corresponding peak in the normal execution time distribution do not coincide with each other.

Specifically, when, as in the above embodiment, the execution time is t, the ratio of the number of program executions for execution time in the normal state is P_{N} (t), and the ratio of the number of program executions for execution time in an abnormal state is P_{A} (t), the median difference, the variance difference, the difference-in-area, and the number of mismatched peaks can be obtained as follows.

That is, when the median difference is represented by ΔCenter (P_{N}, P_{A}), the storage control unit 24 can calculate the median difference using the following equation.

ΔCenter(P_{N},P_{A})={max(t_{A})−min(t_{A})−max(t_{N})−min(t_{N})}/2 (3)

When the variance difference is represented by Δvariance (P_{N}, P_{A}), the storage control unit 24 can calculate the variance difference using the following equation.

$$Δ variance ( {P}_{N} , {P}_{A} ) = {\sum }_{t = 0}^{∞} [ {P}_{A} ( t ) {\{ t - Δ Average ( {P}_{A} ) \}}^{2} - {P}_{N} ( t ) {\{ t - Δ Average ( {P}_{N} ) \}}^{2} ] \\ Average ( P ) = {\sum }_{t = 0}^{∞} t \cdot P ( t ) \qquad ( 4 )$$

When the difference-in-area is represented by area (P_{N}, P_{A}), the storage control unit 24 can obtain the difference-in-area using the following equation.

Δarea(P_{N},P_{A})=Σₜ₌₀^{∞}|P_{A}(t)−P_{N}(t)| (5)

When the number of mismatched peaks is represented by Δpeak_count (P_{N}, P_{A}), the storage control unit 24 can calculate the number of mismatched peaks using the following equation.

Δpeak_count(P_{N},P_{A})=[the number of peaks in disagreement between P_{N}(t) and P_{A}(t)] (6)

Note that the storage control unit 24 may calculate, as the distribution difference, a value that is normalized using at least two of the average value difference, the median difference, the variance difference, the difference-in-area, and the number of mismatched peaks.

For example, when the weighting coefficient set for the average difference is k₁, the weighting coefficient set for the median difference is k₂, the weighting coefficient set for the variance difference is k₃, and the weighting coefficient set for the difference-in-area is k₄ and the weighting coefficient set for the number of unmatched peaks is k₅, the storage control unit 24 can determine the distribution difference Distance using the following equation.

Distance=k₁|ΔAverage(P_{N},P_{A})|+k₂|ΔCenter(P_{N},P_{A})|+k₃|Δvariance(P_{N},P_{A})|+k₄|Δarea(P_{N},P_{A})|+k₅|Δpeak_count(P_{N},P_{A})| (7)

### Modified Example 2

In the above embodiment, the storage control unit 24 generates abnormality information. However, other devices than the monitoring device 18 may generate abnormality information. When another device generates abnormality information, the abnormality information is stored in the storage unit 22 in advance, and the storage control unit 24 is omitted.

### Modified Example 3

In the above embodiment, the distribution difference between the execution time distribution in the machining cycle immediately before occurrence of an abnormality stop and the normal execution time distribution is stored in the storage unit 22 as abnormality information. However, the execution time distribution in the machining cycle immediately before occurrence of an abnormality stop as it is may be stored in the storage unit 22 as abnormality information. In this case, the calculation unit 26 may calculate, as the occurrence probability of abnormality, the distribution difference between the execution time distribution stored as the abnormality information in the storage unit 22 and the execution time distribution generated by the distribution generating unit 20.

### Modified Example 4

In the above embodiment, the calculation unit 26 calculates the difference between the abnormality information (distribution difference) stored as abnormality information in the storage unit 22 and the distribution difference between the execution time distribution generated by the distribution generating unit 20 and the normal execution time distribution. Then, the calculation unit normalizes the calculated difference to thereby obtain the occurrence probability. Specifically, the calculation unit 26 multiplies the calculated difference by a coefficient (degree of influence) and then substitutes the result into a ramp function to thereby obtain a value, which is regarded as the occurrence probability. However, the calculation unit 26 may calculate, as the occurrence probability, the difference between the abnormality information (distribution difference) stored as abnormality information in the storage unit 22 and the distribution difference between the execution time distribution generated by the distribution generating unit 20 and the normal execution time distribution.

### Modified Example 5

In the above embodiment, the threshold setting unit 32 modifies the probability threshold based on whether or not the processing machine 12 has stopped abnormally due to the abnormality that was expected to occur by the determination unit 28, within a predetermined period of time from the determination of the determination unit 28. However, the threshold setting unit 32 may be configured to change the probability threshold only when the processing machine 12 has abnormally stopped due to the abnormality that was expected to occur by the determination unit 28 within a predetermined time from the determination of the determination unit 28.

Further, the threshold setting unit 32 may be configured to change the probability threshold only when the processing machine 12 has not abnormally stopped due to the abnormality that was expected to occur by the determination unit 28 within a predetermined time after the determination of the determination unit 28. Moreover, the threshold setting unit 32 may be configured not to change the probability threshold regardless of whether or not the processing machine 12 has stopped abnormally due to the abnormality that was expected to occur by the determination unit 28, within a predetermined period of time after the determination of the determination unit 28.

### Modified Example 6

In the above embodiment, the threshold setting unit 32 modifies the probability threshold based on whether or not the processing machine 12 has stopped abnormally due to the abnormality that was expected to occur by the determination unit 28, within a predetermined period of time after the determination of the determination unit 28. The threshold setting unit 32 may change the above-mentioned predetermined period of time, depending on the change of the probability threshold. Specifically, the threshold setting unit 32 shortens the above-mentioned period of time when the probability threshold is raised, and lengthens the above-mentioned period of time when the probability threshold is lowered. With this configuration, the erroneous determination of the determination unit 28 can be further reduced.

### Modified Example 7

In the above embodiment, the monitoring device 18 is incorporated in the management server 16, but the monitoring device 18 may be incorporated in one of the multiple control devices 14. In this case, the control device 14 with the monitoring device 18 monitors the processing time of the program executed in the machining cycle of each of the other control devices 14 via network.

The monitoring device 18 may be incorporated in each of the multiple control devices 14. In this case, each monitoring device 18 may store the abnormality information generated by the storage control unit 24 and the result obtained when the threshold setting unit 32 changes the probability threshold, in the management server 16 via network. This makes it possible to share the abnormality information obtained by each monitoring device 18 and the result obtained when the probability threshold is changed.

Further, part of the monitoring device 18 may be incorporated in each of the multiple control devices 14. For example, the distribution generating unit 20 may be incorporated in each of the multiple control devices 14 while the storage unit 22, the storage control unit 24, the calculation unit 26, the determination unit 28, the notification unit 30 and the threshold setting unit 32 may be incorporated in the management server 16. In this case, the processing load on the management server 16 can be reduced.

### Modified Example 8

The above embodiments and modified examples may be arbitrarily combined as long as no technical inconsistency occurs.

[Invention that can be Grasped from the Above]

Inventions that can be grasped from the above-described embodiment and modified examples will be described below.

### <First Invention>

The first invention is a monitoring device (18) for monitoring the processing time of at least one type of program repeatedly executed in a machining cycle of a control device (14) for controlling a processing machine (12). This monitoring device (18) includes: a distribution generating unit (20) configured to generate an execution time distribution that is a frequency distribution of the execution time of the program; a storage unit (22) configured to store at least one kind of abnormality information indicative of an execution time distribution as to an abnormality; a calculation unit (26) configured to calculate the occurrence probability of abnormality, based on information indicating the execution time distribution generated by the distribution generating unit (20) and the abnormality information stored in the storage unit (22); a threshold setting unit (32) configured to set a probability threshold for the abnormality information; and a determination unit (28) configured to determine that there is a sign of an abnormality when the occurrence probability is equal to or higher than the probability threshold.

Thus, a sign of an abnormality can be determined no matter what the cause of an abnormality is, from the tendency of the frequency distribution concerning the execution time of the program repeatedly executed in the machining cycle, and as a result, the abnormalities of the processing machine (12) can be comprehensively grasped.

The threshold setting unit (32) may be configured to increase the probability threshold if the processing machine (12) does not stop abnormally due to the abnormality for which the determination unit (28) has determined that there is a sign of the abnormality, within a predetermined period of time from when the determination unit (28) has determined that there is a sign of the abnormality. This makes it possible to reduce erroneous determination of the determination unit (28).

The threshold setting unit (32) may be configured to delete, from the storage unit (22), the abnormality information corresponding to the probability threshold when the probability threshold becomes equal to or greater than a specified value. This makes it possible to suppress erroneous determination of the determination unit (28).

The threshold setting unit (32) may be configured to decrease the probability threshold if the processing machine (12) stops abnormally due to the abnormality for which the determination unit (28) has determined that there is a sign of the abnormality, within a predetermined period of time from when the determination unit (28) has determined that there is a sign of the abnormality. With this configuration, it is possible to easily grasp a sign of an abnormality that has actually occurred.

The threshold setting unit (32) may be configured to change the predetermined period of time in accordance with a change of the probability threshold. This makes it possible to further reduce erroneous determination of the determination unit (28).

The monitoring device may further include a notification unit (30) configured to, if the determination unit (28) determines that there is a sign of an abnormality, output a notification that there is a possibility of the processing machine (12) being abnormally stopped due to the abnormality for which the determination unit (28) has determined that there is a sign of the abnormality. This makes it possible to alert the operator to pay attention to an abnormality stop of the processing machine (12).

The monitoring device may further include a storage control unit (24) configured to, when the processing machine (12) stops abnormally, store, as the abnormality information, information indicating the execution time distribution generated by the distribution generating unit (20) in a machining cycle immediately before the machining cycle in which the processing machine has stopped abnormally, in the storage unit (22). This makes it possible to capture a characteristic sign every time an abnormality actually occurs in the processing machine (12).

The information indicating the execution time distribution may be a distribution difference between the execution time distribution in the normal state and the execution time distribution generated by the distribution generating unit (20), and the abnormality information may be a distribution difference between the execution time distribution in the normal state and the execution time distribution in the abnormal state. This makes it possible to reduce the calculation load on the calculation unit (26) computing the information and reduce the storage capacity required for the storage unit (22) to store the information, as compared with the case where the information is the frequency distribution itself.

### <Second Invention>

A second invention is a monitoring system (10) including: the above-described monitoring device (18); a plurality of processing machines (12); a plurality of control devices (14) configured to control the respective processing machines (12); and a management server (16) configured to manage the plurality of control devices (14).

The provision of the monitoring device (18) makes it possible to determine a sign of an abnormality no matter what the cause of an abnormality is, from the tendency of the frequency distribution concerning the execution time of the program repeatedly executed in the machining cycle. As a result, the abnormalities of the processing machine (12) can be comprehensively grasped.

### <Third Invention>

A third invention is a monitoring method for monitoring the processing time of at least one type of program repeatedly executed in a machining cycle of a control device (14) for controlling a processing machine (12), including: a distribution generating step (S3) of generating an execution time distribution that is a frequency distribution of the execution time of the program; a calculating step (S13) of calculating the occurrence probability of abnormality, based on the information indicating the execution time distribution generated at the distribution generating step (S3) and at least one kind of abnormality information indicative of an execution time distribution as to an abnormality stored in a storage unit (22); a threshold setting step (S15) of setting a probability threshold for the abnormality information; and a determining step (S23) of determining that there is a sign of an abnormality when the occurrence probability is equal to or higher than the predetermined probability threshold.

Thus, a sign of an abnormality can be determined no matter what the cause of an abnormality is, from the tendency of the frequency distribution concerning the execution time of the program repeatedly executed in the machining cycle, and as a result, the abnormalities of the processing machine (12) can be comprehensively grasped.

The monitoring method may further include a threshold increasing step (S27) of increasing the probability threshold if the processing machine (12) does not stop abnormally due to the abnormality for which the determining step (S23) has determined that there is a sign of the abnormality, within a predetermined period of time from when the determining step (S23) has determined that there is a sign of the abnormality. This makes it possible to reduce erroneous determination.

The threshold increment step (S27) may delete, from the storage unit (22), the abnormality information corresponding to the probability threshold when the probability threshold becomes equal to or greater than a specified value. This makes it possible to suppress erroneous determination.

The monitoring method may further include a threshold decreasing step (S28) of decreasing the probability threshold if the processing machine (12) stops abnormally due to the abnormality for which the determining step (S23) has determined that there is a sign of the abnormality, within a predetermined period of time from when the determining step (S23) has determined that there is a sign of the abnormality. With this configuration, it is possible to easily grasp a sign of an abnormality that has actually occurred.

The monitoring method may further include a notifying step (S24) of, if the determining step (S23) determines that there is a sign of an abnormality, outputting a notification that there is a possibility of the processing machine (12) being abnormally stopped due to the abnormality for which the determining step (S23) has determined that there is a sign of the abnormality. This makes it possible to alert the operator to pay attention to an abnormality stop of the processing machine (12).

The monitoring method may further include a storage controlling step (S14) of, when the processing machine (12) stops abnormally, storing, as the abnormality information, information indicating the execution time distribution generated in a machining cycle immediately before the machining cycle in which the processing machine has stopped abnormally, in the storage unit (22). This makes it possible to capture a characteristic sign every time an abnormality actually occurs in the processing machine (12).

What is claimed is:

1. A monitoring device for monitoring a processing time of at least one type of program repeatedly executed in a machining cycle of a control device for controlling a processing machine, comprising:
a distribution generating unit configured to generate an execution time distribution that is a frequency distribution of an execution time of the program;
a storage unit configured to store at least one kind of abnormality information indicative of an execution time distribution as to an abnormality;
a calculation unit configured to calculate an occurrence probability of abnormality, based on information indicating the execution time distribution generated by the distribution generating unit and the abnormality information stored in the storage unit;
a threshold setting unit configured to set a probability threshold for the abnormality information; and
a determination unit configured to determine that there is a sign of an abnormality when the occurrence probability is equal to or higher than the probability threshold.

2. The monitoring device according to claim 1, wherein the threshold setting unit is configured to increase the probability threshold if the processing machine does not stop abnormally due to the abnormality for which the determination unit has determined that there is a sign of the abnormality, within a predetermined period of time from when the determination unit has determined that there is a sign of the abnormality.

3. The monitoring device according to claim 2, wherein the threshold setting unit is configured to delete, from the storage unit, the abnormality information corresponding to the probability threshold when the probability threshold becomes equal to or greater than a specified value.

4. The monitoring device according to claim 2, wherein the threshold setting unit is configured to change the predetermined period of time in accordance with a change of the probability threshold.

5. The monitoring device according to claim 1, wherein the threshold setting unit is configured to decrease the probability threshold if the processing machine stops abnormally due to the abnormality for which the determination unit has determined that there is a sign of the abnormality, within a predetermined period of time from when the determination unit has determined that there is a sign of the abnormality.

6. The monitoring device according to claim 5, wherein the threshold setting unit is configured to change the predetermined period of time in accordance with a change of the probability threshold.

7. The monitoring device according to claim 1, further comprising a notification unit configured to, if the determination unit determines that there is a sign of an abnormality, output a notification that there is a possibility of the processing machine being abnormally stopped due to the abnormality for which the determination unit has determined that there is a sign of the abnormality.

8. The monitoring device according to claim 1, further comprising a storage control unit configured to, when the processing machine stops abnormally, store, as the abnormality information, information indicating the execution time distribution generated by the distribution generating unit in a machining cycle immediately before the machining cycle in which the processing machine has stopped abnormally, in the storage unit.

9. The monitoring device according to claim 1, wherein the information indicating the execution time distribution comprises a distribution difference between the execution time distribution in a normal state and the execution time distribution generated by the distribution generating unit, and the abnormality information comprises a distribution difference between the execution time distribution in the normal state and the execution time distribution in an abnormal state.

10. A monitoring system comprising:
the monitoring device according to claim 1;
a plurality of the processing machines;
a plurality of the control devices configured to control the respective processing machines; and
a management server configured to manage the plurality of control devices.

11. A monitoring method for monitoring a processing time of at least one type of program repeatedly executed in a machining cycle of a control device for controlling a processing machine, comprising:
a distribution generating step of generating an execution time distribution that is a frequency distribution of an execution time of the program;
a calculating step of calculating an occurrence probability of abnormality, based on information indicating the execution time distribution generated at the distribution generating step and at least one kind of abnormality information indicative of an execution time distribution as to an abnormality stored in a storage unit;
a threshold setting step of setting a probability threshold for the abnormality information; and
a determining step of determining that there is a sign of an abnormality when the occurrence probability is equal to or higher than the predetermined probability threshold.

12. The monitoring method according to claim 11, further comprising a threshold increasing step of increasing the probability threshold if the processing machine does not stop abnormally due to the abnormality for which the determining step has determined that there is a sign of the abnormality, within a predetermined period of time from when the determining step has determined that there is a sign of the abnormality.

13. The monitoring method according to claim 12, wherein the threshold increasing step deletes, from the storage unit, the abnormality information corresponding to the probability threshold when the probability threshold becomes equal to or greater than a specified value.

14. The monitoring method according to claim 11, further comprising a threshold decreasing step of decreasing the probability threshold if the processing machine stops abnormally due to the abnormality for which the determining step has determined that there is a sign of the abnormality, within a predetermined period of time from when the determining step has determined that there is a sign of the abnormality.

15. The monitoring method according to claim 11, further comprising a notifying step of, if the determining step determines that there is a sign of an abnormality, outputting a notification that there is a possibility of the processing machine being abnormally stopped due to the abnormality for which the determining step has determined that there is a sign of the abnormality.

16. The monitoring method according to claim 11, further comprising a storage controlling step of, when the processing machine stops abnormally, storing, as the abnormality information, information indicating the execution time distribution generated in a machining cycle immediately before the machining cycle in which the processing machine has stopped abnormally, in the storage unit.
